(19) United States
(12) Patent Application Publication
(10) Pub. No.: US 2016/0089732 A1
(43) Pub. Date: Mar. 31, 2016

(54) HAND SAW

(71) Applicant: HACKSAW & KNIFE MANUFACTORY CO., LTD., Taiping City (TW)

(72) Inventor: Tien-Yu Huang, Taichung City (TW)

(21) Appl. No.: 14/500,643

(22) Filed: Sep. 29, 2014

(51) Int. Cl. B23D 49/12; B23D 51/12

(52) U.S. Cl. CPC B23D 49/12; B23D 51/125

(57) ABSTRACT

A hand saw includes a main body, a reinforcing member and a fastening assembly. The main body includes a bow body and a grip portion connected to the bow body, and a receiving slot is recessed along the bow body. An end of the bow body far from the grip portion has at least one first positioning column for a saw blade to be positioned thereon. A rigidity of the reinforcing member is higher than that of the bow body. The shapes of the reinforcing member and the receiving slot are substantially complementary. The reinforcing member is fixedly disposed in the receiving slot. The fastening assembly is attached to the main body and has at least one second positioning column for the other end of the saw blade to be positioned thereon, and is movably adjustable for tensionally fixing the saw blade to the main body.

### BACKGROUND OF THE INVENTION

1. Field of the Invention

The present invention relates to a saw, and more particularly to a hand saw.

2. Description of the Prior Art

Conventionally, a hand saw is designed as a one-piece component with a tubular or solid bow body, and relative two sides of the bow body has positioning columns for a saw blade to be positioned thereon so as to hook two ends of the saw blade on the two positioning columns. Then, the saw blade can be tensioned and tightened by a lever or a screw lock assembly so as to conduct a sawing operation.

A conventional hand saw as disclosed in TW M268163, considering the structural strength of the bow body, usually has the one-piece component with the tubular or solid bow body. However, the one-piece component with the tubular or solid bow body makes the volume, weight and cost increase and is user-unfriendly. In addition, in view of the structure of the conventional hand saw, a user needs to swing a rear hook member forward and backward to disassemble or assemble the hand saw, and there are no mechanisms which can restrict or position the rear hook member effectively. Therefore, the hand saw is inconvenient to use, and the saw blade is prone to loose.

The present invention is, therefore, arisen to obviate or at least mitigate the above-mentioned disadvantages.

### SUMMARY OF THE INVENTION

The main object of the present invention is to provide a hand saw which is low-weighted and low-cost with great structural strength. A force can be transmitted and dispersed more evenly, so the hand saw is not easy to be damaged. In addition, the hand saw can be provided with couples of positioning columns for a saw blade to be positioned thereon for various operational requirements.

To achieve the above and other objects, the present invention provides a hand saw, including a main body, a reinforcing member and a fastening assembly. The main body includes a bow body and a grip portion connected to the bow body. A receiving slot is recessed along an extending direction of the bow body, and an end of the bow body far from the grip portion is formed with at least a first positioning column for an end of the saw blade to be positioned thereon. The reinforcing member has a rigidity higher than a rigidity of the bow body, and a shape of the reinforcing member is substantially complementary to a shape of the receiving slot. The reinforcing member is fixedly disposed in the receiving slot. The fastening assembly is attached to the main body and near the grip portion and has at least one second positioning column for the other end of the saw blade to be positioned thereon. The fastening assembly is adjustable relative to the main body for tensionally fixing the saw blade to the main body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of a hand saw of the present invention;

FIG. 2 is a breakdown drawing of a preferred embodiment of the hand saw of the present invention;

FIG. 3 is a partial breakdown drawing of a preferred embodiment of the hand saw of the present invention;

FIG. 4 is a cross-sectional view of FIG. 1 along A-A;

FIG. 5 is a partial cross-sectional drawing of a preferred embodiment of the hand saw of the present invention; and

FIG. 6 is another stereogram of a preferred embodiment of the hand saw of the present invention.

### DETAILED DESCRIPTION OF THE PREFERRED EMBODIMENTS

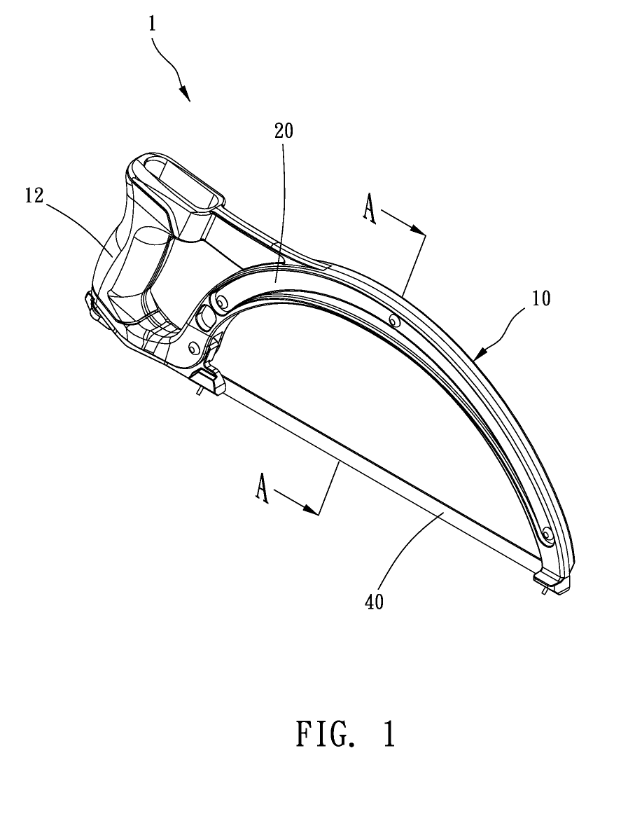

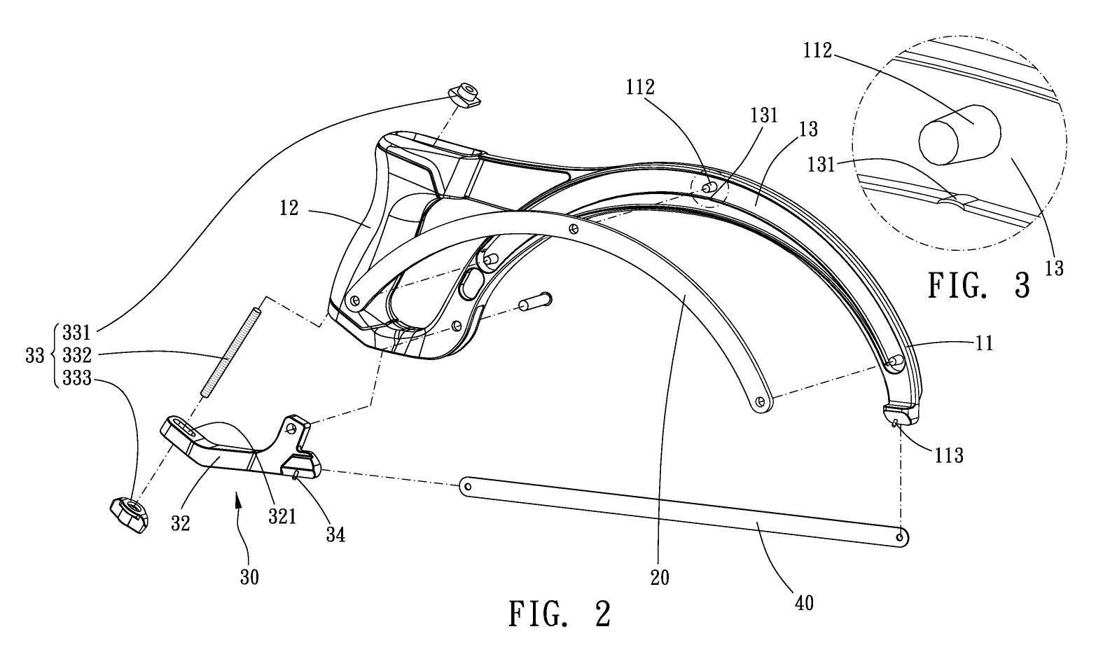

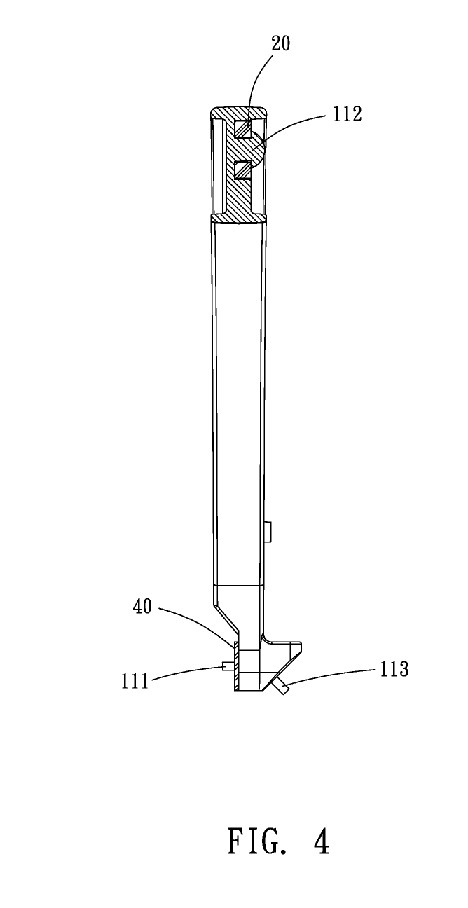

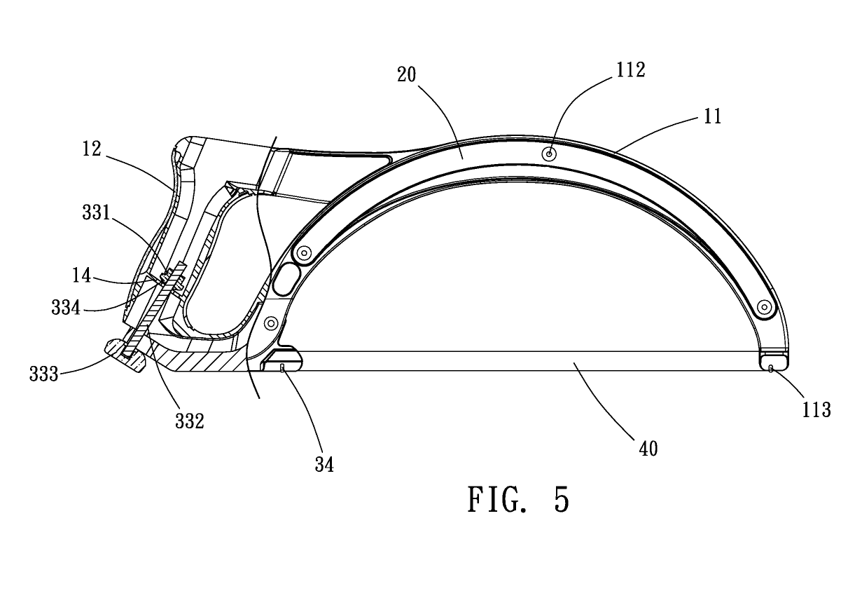

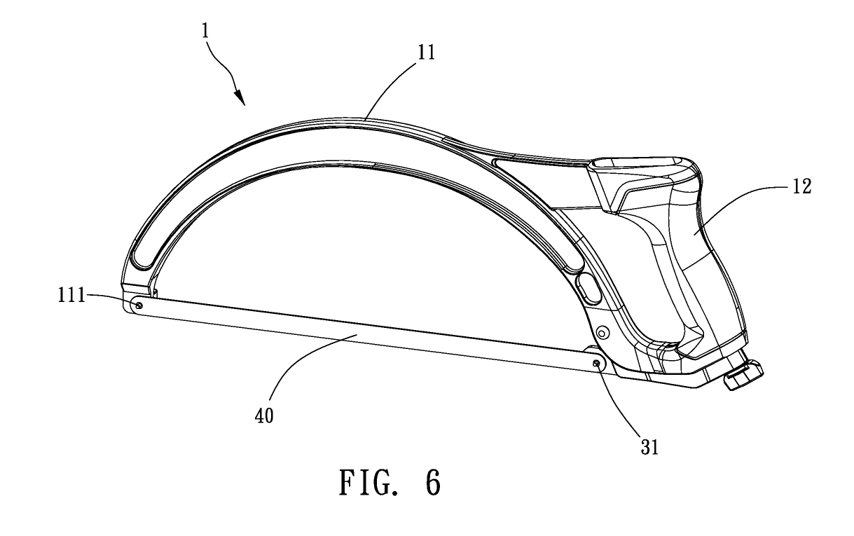

Please refer to FIGS. 1 to 6 for a preferred embodiment of a hand saw 1 of the present invention, including a main body 10, a reinforcing member 20 and a fastening assembly 30.

The main body 10 includes a bow body 11 and a grip portion 12 connected to the bow body 11. More specifically, the bow body 11 is made of aluminum and preferably integrally formed. A cross-section of the bow body 11 is substantially I-shaped, and such a structure can maintain greater structural strength, decrease weight largely and save material and cost. A receiving slot 13 is recessed along an extending direction of the bow body 11, and a depth of the receiving slot 13 is greater than a thickness of the reinforcing member 20; therefore, the reinforcing member 20 can be received in the receiving slot 13 completely. An end of the bow body far from the grip portion 12 is formed with at least one first positioning column 111 for an end of a saw blade 40 to be positioned thereon. The reinforcing member 20 has a rigidity higher than a rigidity of the bow body 11. A shape of the reinforcing member 20 is substantially complementary to a shape of the receiving slot 13. The reinforcing member 20 is stably and fixedly disposed in the receiving slot 13. Preferably, the reinforcing member 20 can be made of iron, steel, ferrous alloy, aluminum alloy, aluminum magnesium alloy or any material that can increase the structural strength of the bow body 11.

More specifically, the receiving slot 13 extends on a plane, and the reinforcing member 20 is an arced sheet parallel to the plane; therefore, the reinforcing member 20 can have great structural strength even if it is thin. A plurality of riveting column 112 (may be integrally formed with the bow body 11 or separately formed) is disposed on a bottom face of the receiving slot 13. The riveting columns 112 are disposed through the reinforcing member 20 to be riveted to the reinforcing member 20 so as to make sure that the reinforcing member 20 and the bow body are tightly connected and have great structural strength, and a force applied to the bow body 11 can be transmitted and dispersed to the reinforcing member 20 more evenly.

In this embodiment, a plurality of abutting portions 131 are radially protruded on a wall of the receiving slot 13 in intervals. The reinforcing member 20 abuts against between the abutting portions 131, and preferably, each the abutting portion 131 and one the riveting column 112 are on the same radial extending direction; therefore, even if a dimension of the reinforcing member 20 is slightly smaller than a dimension of the receiving slot 13, the reinforcing member 20 can be stably fixed to maintain the structural strength. The reinforcing member 20 can be tight fit in the receiving slot 13 to maintain great structural strength, and the force applied to the bow body 11 can be transmitted and dispersed to the reinforcing member 20 more evenly.

The fastening assembly 30 is attached to the main body 10 and near the grip portion 12, and the fastening assembly 30 is formed with at least one second positioning column 31 for the other end of the saw blade 40 to be positioned thereon. The fastening assembly is 30 movably adjustable relative to the main body 10 for tensionally fixing the saw blade 40 to the main body 10. Specifically, the fastening assembly 30 includes a lever 32 pivoted to the main body 10 and a position-limiting assembly 33 connected to the main body 10. The lever 32 is formed with the second positioning column 31 at an end and a through slot 321 at the other end. An end of the position-limiting assembly 33 is disposed through the through slot 321 and adjustabe to position the lever 32.

In this embodiment, a blocking portion 14 is disposed in an interior of the main body 10. The position-limiting assembly 33 includes a blocking head 331 disposed in the main body 10 and being blockably abutting against the blocking portion 14, a connecting rod 332 connected to the blocking head 331 and extending outside the main body 10 and an adjusting member 333 outside the main body 10 and adjustably disposed on the connecting rod 332. The connecting rod 332 is disposed through the through slot 321, and the lever 32 is restricted between the adjusting member 333 and the main body 10. For example, the blocking head 331 and the adjusting member 333 are formed with a screw hole respectively, two ends of the connecting rod 332 are formed with a threaded section respectively, and the blocking head 331 and the adjusting member 333 are adjustably screwed to two ends of the connecting rod 332. The blocking head 331 includes an arced face 334 facing the blocking portion 14 and slidably abutting against the blocking portion 14. The arced face 334 can decrease the resistance in the process of the lever 32 fastening the saw blade 40 and decrease the abrasion among members. Furthermore, when assembling or disassembling the saw blade 40, a swinging range of the lever 32 can be increased to make the process of assembling or disassembling the saw blade 40 smooth.

Preferably, an end of the bow body 11 far from the grip portion 12 is formed with at least one third positioning column 113 for one of the two ends of the saw blade 40 to be positioned thereon. The fastening assembly 30 further has at least one fourth positioning column 34 for the other one of the two ends of the saw blade 40 to be positioned thereon. The first and second positioning columns 111, 31 project toward a first direction, and the third and fourth positioning columns 113, 34 project toward a second direction. Preferably, an included angle of the second and first directions is smaller than 90 degrees or could be in any degree equal to or larger than 90 degrees. Therefore, the saw blade 40 can be selectively assembled to the corresponding first and second positioning columns 111, 31 or the corresponding third and fourth positioning columns 113, 34 for various operational requirements.

Give the above, the bow body of the hand saw of the present invention can be made of aluminum. Through assembling the reinforcing member having higher rigidity into the receiving slot of the bow body, the weight and cost of the hand saw are decreased, and the bow body has great structural strength and won't be deformed or damaged easily.

The reinforcing member can abut against a part or whole of the wall of the receiving slot or be riveted to the reinforcing member through disposing the riveting column through the reinforcing member in order to make sure that the reinforcing member and the bow body are tightly connected. Therefore, the reinforcing member and the bow body have great structural strength, and the force applied to the bow body is transmitted and dispersed to the reinforcing member more evenly.

In addition, the hand saw can be provided with couples of positioning columns for the two ends of the saw blade to be positioned thereon for various operational requirements.

Although particular embodiments of the invention have been described in detail for purpose of illustration, various modifications and enhancements may be made without departing from the spirit and scope of the invention. Accordingly, the invention is not to be limited except as by the appended claims.

What is claimed is:

1. A hand saw, including:
a main body, including a bow body and a grip portion connected to the bow body, a receiving slot recessed along an extending direction of the bow body, an end of the grip portion far from the bow body having at least one first positioning column for an end of a saw blade to be positioned thereon; a reinforcing member, having a rigidity higher than a rigidity of the bow body, a shape of the reinforcing member substantially complementary to a shape of the receiving slot, the reinforcing member fixedly disposed in the receiving slot; and
a fastening assembly, attached to the main body and being near the grip portion, having at least one second positioning column for the other end of the saw blade to be positioned thereon, the fastening assembly being movably adjustable relative to the main body for tensionally fixing the saw blade on the main body.

2. The hand saw of claim 1, wherein the receiving slot extends on a plane, and the reinforcing member is an arced sheet parallel to the plane.

3. The hand saw of claim 1, wherein a plurality of riveting columns are disposed on a bottom face of the receiving slot, and the riveting columns are disposed through the reinforcing member to be riveted to the reinforcing member.

4. The hand saw of claim 1, wherein the bow body is made of aluminum, and the reinforcing member is made of iron, steel, ferrous alloy, aluminum alloy or aluminum-magnesium alloy.

5. The hand saw of claim 1, wherein a plurality of abutting portions are radially protruded from a wall of the receiving slot in intervals, and the reinforcing member abuts against between the abutting portions.

6. The hand saw of claim 1, wherein the reinforcing member is tight fit in the receiving slot.

7. The hand saw of claim 1, wherein the fastening assembly includes a lever pivoted to the main body and a position-limiting assembly connected to the main body, the lever is formed with the second positioning column at an end and a through slot at the other end, and an end of the position-limiting assembly is disposed through the through slot and adjustable to position the lever.

8. The hand saw of claim 7, wherein an interior of the main body has a blocking portion, the position-limiting assembly includes a blocking head disposed in the main body and being blockably abutting against the blocking portion, a connecting rod connecting to the blocking head and extending outside the main body and an adjusting member outside the main body and adjustably assembled to the connecting rod, the connecting rod is disposed through the through slot, and the lever is restricted between the adjusting member and the main body.

9. The hand saw of claim 8, wherein the blocking head includes an arced face facing the blocking portion and slidably abutting against the blocking portion.

10. The hand saw of claim 1, wherein an end of the bow body far from the grip portion is formed with at least one third positioning column for one of the two ends of the saw blade to be positioned thereon, the fastening assembly further has at least one fourth positioning column for the other one of the two ends of the saw blade to be positioned thereon, the first and second positioning columns project toward a first direction, the third and fourth positioning columns project toward a second direction, and an included angle of the second and first directions is smaller than 90 degrees.
